(19) United States
(12) Patent Application Publication
(10) Pub. No.: US 2003/0084192 A1
(43) Pub. Date: May 1, 2003

(54) NETWORK INTERFACE FOR PORTABLE COMPUTERS

(76) Inventors: MICHAEL NGUYEN, HOUSTON, TX (US); DAN FORLENZA, CYPRESS, TX (US); TIM ZHANG, SPRING, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/395,781

(22) Filed: Sep. 14, 1999

(51) Int. Cl. G06F 15/16

(52) U.S. Cl. 709/250

(57) ABSTRACT

A portable computer and replicator particularly suited for use in a network environment are disclosed. The portable computer has a digital network controller located therein and adapted to receive digital network signals from an external connector. The replicator is located external to the portable computer and has an analog network circuit adapted to receive analog signals from a network and deliver corresponding digital network signals to the external connector on the portable computer to provide a high-bandwidth network connection.

### BACKGROUND OF THE INVENTION

1. Field of the Invention

This invention is generally directed to a network interface for a personal computer, and, more particularly, to interfacing a portable computer with a network.

2. Description of the Related Art

Historically, portable computers have been used outside of the office environment in a stand-alone mode. That is, the normal usage of a portable computer involves transporting it to a remote site and using it in a stand-alone mode to perform work on data/files contained on its own disk drive using programs likewise stored on its own disk drive. Generally, portable computers have not been routinely operated in conjunction with a computer network during the majority of their use.

As the power of portable computers has increased to put them more on par with desktop or tower units, more and more users have found that portable computers may be effectively used with a computer network system. Accordingly, manufacturers have developed docking stations or replicators that are relatively permanently located on the user desktop and removably receive the portable computer. Communications within the portable computer are effected, as in desktop units, over a high-speed product component interface (PCI) bus. Communications between the portable computer and the docking station/replicator, however, are effected through dedicated docking port normally located on a rear surface of the portable computer.

Historically, the docking station/replicator contains all of the hardware useful in interfacing the portable computer with the network, such as an Ethernet network. Thus, the Ethernet connection to the portable computer is made through the dedicated docking port located on a standard portable computer. These ports, however, are insufficient in speed to accommodate true high-speed analog network signals. Accordingly, while portable computers have the computing power to operate on par with desktop units, they are handicapped in a network environment by a bottle-neck created at the standard input/output ports, resulting in slow network communications.

Extending the PCI bus exterior to the portable computer so that it may be directly connected to the docking station/replicator, is expensive. The PCI bus is comprised of 50 traces, and is very sensitive to the length of these traces. Accordingly, extending the PCI bus external to the portable computer will result in excessively long traces that interfere with the speed and timing of operation of the PCI bus.

The present invention is directed to overcoming or at least reducing the effects of one or more of the problems set forth above.

### SUMMARY OF THE INVENTION

In one aspect of the present invention, an apparatus is provided. The apparatus includes a computer that has a digital network controller located therein. The digital network controller is adapted to receive digital network signals from an external connector. A replicator is located external the computer and has an analog network circuit adapted to receive analog signals from a network and deliver corresponding digital network signals to the external connector on the computer.

In another aspect of the present invention, a portable computer having a digital network controller located therein is provided. The digital network controller is adapted to receive digital network signals from an external connector. The external connector is adapted to be coupled to a replicator located external to the computer and has an analog network circuit adapted to receive analog signals from a network and deliver corresponding digital network signals to the external connector on the portable computer.

In yet another aspect of the present invention, a method is provided for interfacing a portable computer with a network. The method includes: coupling a replicator to a network; delivering digital network signals to an external connector on the portable computer; receiving the digital network signals at a digital network controller located within the portable computer; converting the digital network signals to high-speed bus signals; and delivering the high-speed bus signals onto an internal bus within the portable computer.

### BRIEF DESCRIPTION OF THE DRAWINGS

The invention may be understood by reference to the following description taken in conjunction with the accompanying drawings, in which like reference numerals identify like elements, and in which:

FIG. 1A is a schematic diagram of a portable computer;

FIG. 1B is a side view of the portable computer of FIG. 1A interfaced with a replicator;

FIG. 2 is block diagram of the major control circuits contained within the portable computer and replicator of FIG. 1;

FIG. 3 is an electrical schematic of a local area network (LAN) controller within the portable computer of FIGS. 1 and 2; and

FIG. 4 is an electrical schematic of a circuit used to mask the presence of the LAN controller within the portable computer of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

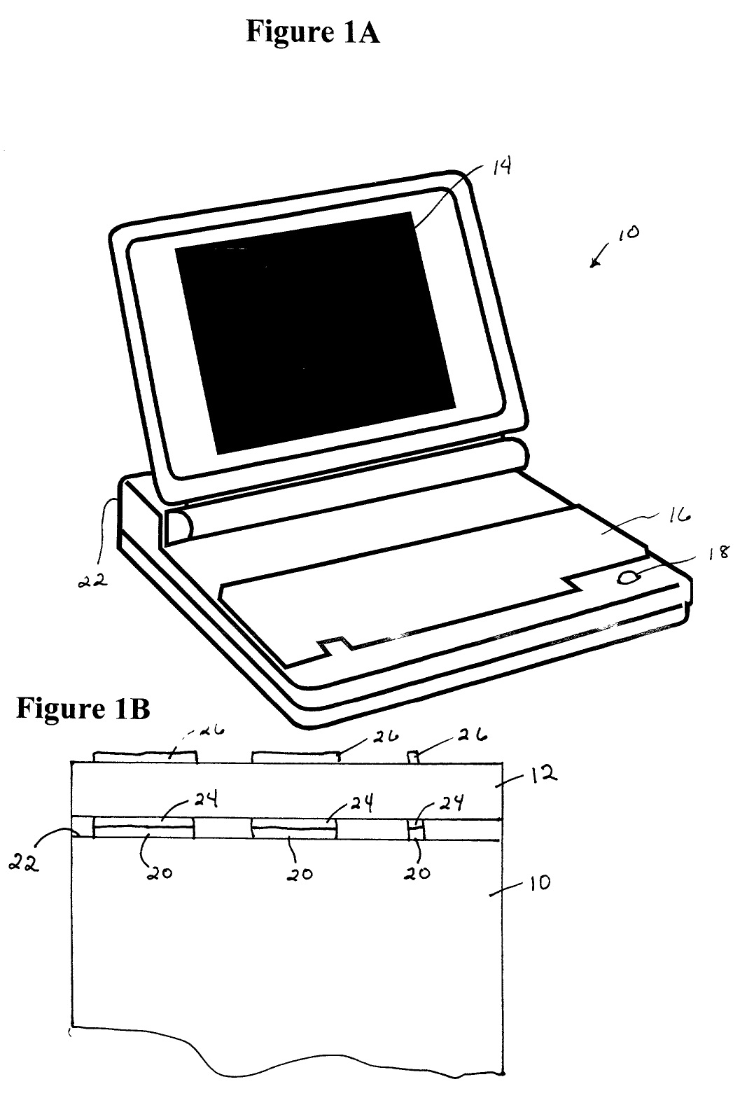

Referring now to FIGS. 1A and 1B, a schematic diagram of a portable computer 10 and a replicator 12 is shown. The portable computer 10 includes a plurality of conventional components, such as might be found in any of a variety of commercially available portable computers (e.g., Compaq Presario® 1625). For example, the portable computer 10 includes a liquid crystal display 14, a keyboard 16, a rollerball 18, and a plurality of conventional electrical connectors 20 coupled to a back side 22 thereof (see top view of FIG. 1B).

As shown in FIG. 1B, the replicator 12 also includes a first plurality of electrical connectors 24 configured and arranged to mate with the electrical connectors 20 on the portable computer 10. The replicator 12 also includes a second plurality of connectors 26, which are generally directly interfaced with the first plurality of connectors 24. One purpose of the replicator 12 is to provide a means for quickly and accurately connecting the portable computer to peripherals located in the office. That is, a printer (not shown), a mouse (not shown), a keyboard (not shown), a monitor (not shown), etc. may be relatively permanently coupled to the appropriate connectors 26, which, via the replicator 12, are appropriately coupled to the portable computer 10. Thus, the user may simply couple the portable computer 10 to the replicator 12 and all connections to all of the various peripherals (not shown) are simultaneously made. That is, the users need not laboriously connect/disconnect each peripheral device (not shown) to the portable computer 10 to switch between portable and office use.

Historically, replicators have also included a network interface circuit that includes both a digital network interface controller and analog interface circuitry. The controller is coupled to the portable computer 10 through one of the conventional electrical connectors 20. As discussed above, the bandwidth available through the conventional electrical connectors 20 is insufficient to provide high-speed network access.

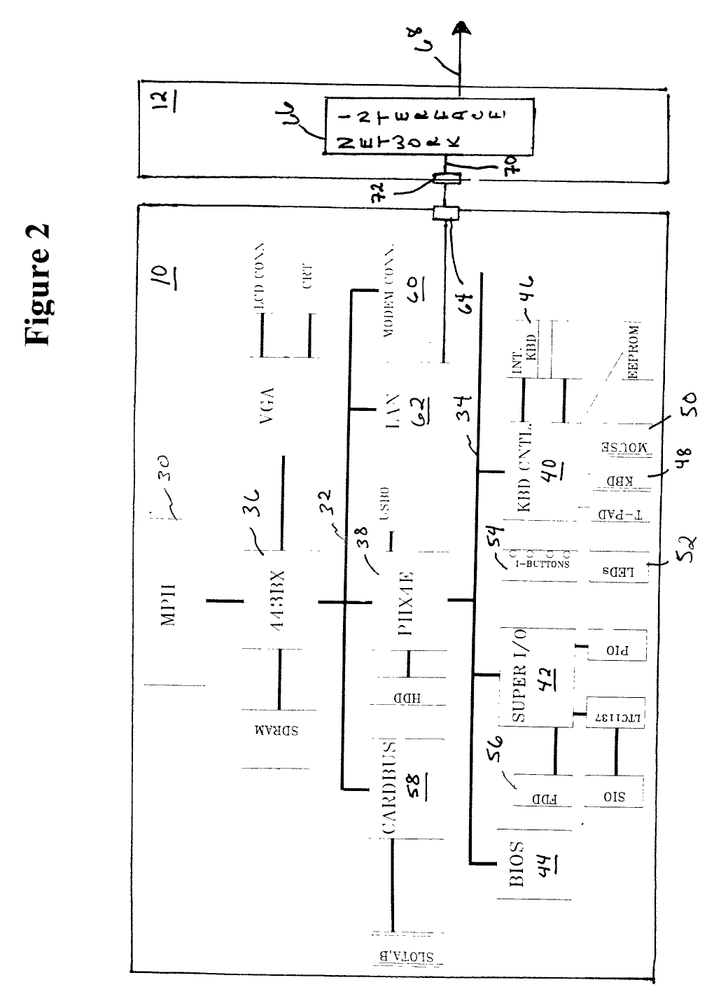

A generalized block diagram of a control architecture that may be employed in one embodiment of the portable computer 10 and replicator 12 is shown in FIG. 2. The architecture generally includes a microprocessor 30 coupled to a plurality of components through a pair of buses, a PCI bus 32 and an ISA bus 34. A pair of bridge circuits 36, 38 interface the microprocessor 30 with the PCI bus 32, and the PCI bus 32 with the ISA bus 34, respectively to allow for communications between the microprocessor 30 and any device connected to either the PCI bus or the ISA bus. A variety of devices may be coupled to the ISA bus, such as a keyboard controller 40, an I/O controller 42, and a BIOS 44. The keyboard controller 40 provides a plurality of functions, but generally operates to interface user accessible/viewable functions, including an interface to an internal keyboard 46, an external keyboard connector 48, an external mouse connector 50, LEDs 52, internet buttons 54, and the like. The I/O controller 42 provides an interface to, for example, a floppy disk drive 56.

The PCI bus 32 may also be coupled to a plurality of components, such as a cardbus 58, a modem 60, and a digital network interface controller 62. The digital network interface controller 62 generally operates to receive digital network signals, such as those present within an Ethernet network, convert them to high-speed bus signals in a format compatible with the PCI bus 32, and transmit the high-speed bus signals onto the PCI bus 32. The digital network interface controller 62 receive these digital network signals over an external connector 64, which in the disclosed embodiment is located on the rear surface of the portable computer 10, such that it directly couples with a mating connector located on the replicator 12. In one embodiment, the digital network interface controller 62 is a local area network (LAN) controller manufactured by Intel Corporation as part number 21143. The network interface controller 62 is adapted to receive digital network signals from the replicator 12 through a connection 64, which may be located on a back surface 22 of the portable computer 10 (see FIG. 1B). While the embodiment disclosed herein is in conjunction with an Ethernet network, it is envisioned that the invention would have application in any of a variety of network environments, including but not limited networks having token ring connections, modem connections, and the like.

Similarly, the replicator 12 has a variety of components located therein, such as a network interface 66 for coupling with a network, such as an Ethernet network. The network interface 66 is of conventional design and generally functions to receive digital network signals over lines 68, pass those signals over a line 70 to an external connector 72 on the replicator 12. When the portable computer 10 is properly mated with the replicator 12 the connector 64 mates with the connector 72 so that the digital network signals are transmitted to the LAN controller 62.

This configuration advantageously delivers a relatively high-bandwidth digital signal to the LAN controller 62. Because the LAN controller 62 is directly coupled to the high-bandwidth PCI bus 32, network communications are provided at a higher speed than would otherwise be possible. Extending the PCI bus outside the portable computer 10 as an alternative method of providing high-speed network communications is undesirable because the PCI bus is sensitive to trace lengths. That is, extending the PCI bus can lead to instabilities in the PCI bus, which, of course, can affect the overall operation of the portable computer 10.

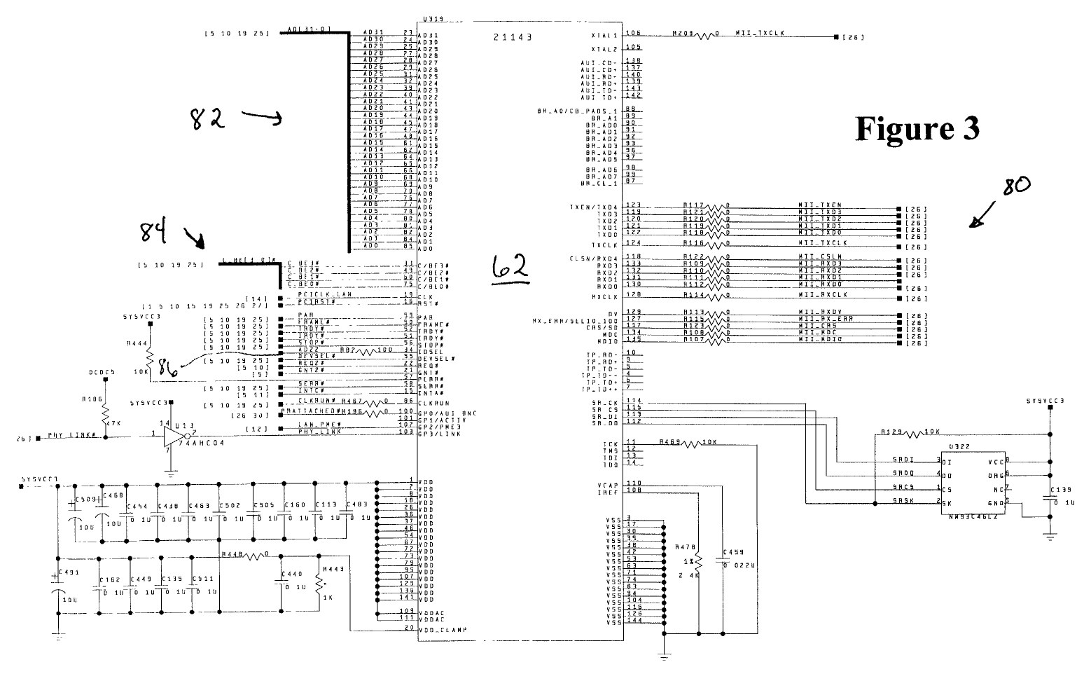

Referring now to FIG. 3, an electrical schematic of the LAN controller 62 is shown. The physical lines 80 extending between the LAN controller 62 and the connector 64 include five transmit lines, five receive lines, a transmit clock, a receive clock, and five control lines, as is conventional. The LAN controller 62 is also coupled to the PCI bus 32 by thirty-two data lines 82 and twenty-two control lines 84, as is conventional. Operation of the LAN controller 62 is well-known to those skilled in the art and will not be discussed in detail herein to avoid unnecessarily complicating the disclosure. Further detailed information regarding the LAN controller 62 may be found in Intel Data Sheet 21143, which is herein incorporated by reference in its entirety. In one embodiment of the portable computer 10, an operating system, such as Windows, is used to control its overall operation. During start-up, the Windows operating system executes a routine generally known as PCI configuration cycle. During the PCI configuration cycle, the Windows operating system detects and configures all devices coupled to the PCI bus 32. Thus, without some intervention the Windows operating system would detect the LAN controller 62 and attempt to configure it, whether or not the portable computer 10 was actually attached to the replicator 12, and thus the network. In instances where the portable computer 10 is not connected to the replicator 12, attempting to configure the portable computer 10 for network operation can lead to slow, and possibly incorrect, operation of the portable computer 10. To enable the LAN controller 62, the portable computer 10 issues a control signal, IDSEL, which is ultimately delivered to an input terminal 82 of the LAN controller 62.

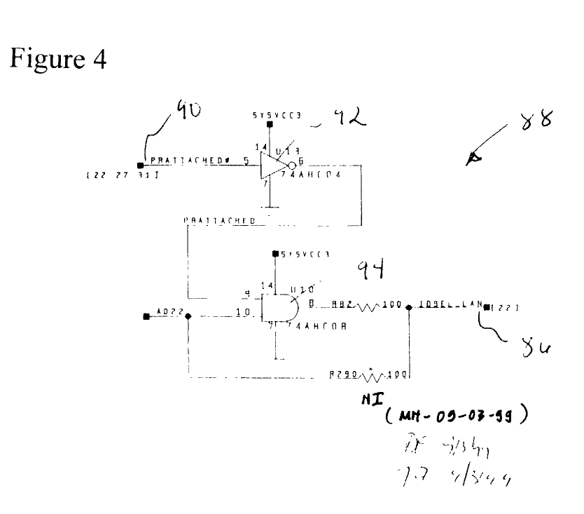

In one embodiment of the portable computer 10 a control circuit 88 is included to intercept and mask the IDSEL signal when the portable computer 10 is not coupled with the replicator 12. As shown in FIG. 4, the control circuit 88 receives a control signal (PRATTACHED) over a line 90 indicative of the portable computer 10 being coupled with the replicator 12. Generation of the control signal, PRATTACHED, may be accomplished in a variety of conventional ways, such as pulling the line 90 to a logically high voltage level with a pull-up resistor (not shown). The line 90 extends to one of the external connectors 20, and the corresponding connector 24 on the replicator 12 is coupled to a logically low voltage level, such as ground. Thus, when the portable computer 10 is not coupled with the replicator 12, the line 90 is pulled to a logically high level, and when the portable computer 10 is coupled with the replicator 12, the line 90 is pulled to a logically low level.

An inverter 92 has an input terminal coupled to the line 90 and an output terminal coupled to a first input of an AND gate 94. A second input of the AND gate 94 receives the IDSEL control signal. Finally, an output terminal of the AND gate is coupled to the line 86, and thus, to the LAN controller 62. Therefore, when the portable computer 10 is coupled with the replicator 12, the line 90 is pulled to a logically low voltage level and the inverter 92 delivers a logically high voltage level to the first input of the AND gate 94. Thus, the AND gate 94 is enabled to pass the IDSEL control signal to the LAN controller 62. On the other hand, when the portable computer 10 is not coupled with the replicator 12, the line 90 is pulled to a logically high voltage level, causing the inverter 92 to deliver a logically low voltage level to the first input of the AND gate 94. The AND gate 94 is thus disabled from delivering the IDSEL control signal to the LAN controller 62 when the portable computer 10 and replicator 12 are not coupled together.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An apparatus, comprising:
a computer having a digital network controller located therein and adapted to receive digital network signals from an external connector; and
a replicator located external said computer and being capable of being coupled to said computer, said replicator having an analog network circuit adapted to receive analog signals from a network and deliver corresponding digital network signals to the external connector on said computer.

2. An apparatus, as set forth in claim 1, wherein said digital network controller is coupled to a peripheral component interface bus within said computer.

3. An apparatus, as set forth in claim 10, wherein said network includes an Ethernet connection, a token ring connection, and a modem connection.

4. An apparatus, as set forth in claim 1, wherein said replicator is adapted to be coupled to a plurality of peripheral devices.

5. An apparatus, as set forth in claim 1, wherein said computer is a portable computer.

6. An apparatus, as set forth in claim 1, including a control circuit capable of preventing the digital network controller from being configured in response to detecting said replicator being disconnected from said computer.

7. An apparatus, as set forth in claim 6, wherein said control circuit masks the delivery of a control signal to said digital network controller in response to detecting said replicator being disconnected from said computer.

8. A portable computer having a digital network controller located therein and adapted to receive digital network signals from an external connector, said external connector being adapted to be coupled to a replicator located external said computer and having an analog network circuit adapted to receive analog signals from a network and deliver corresponding digital network signals to the external connector on said portable computer.

9. An apparatus, as set forth in claim 8, wherein said digital network controller is coupled to a peripheral component bus within said computer.

10. An apparatus, as set forth in claim 8, wherein said network includes an Ethernet connection, a token ring connection, and a modem connection.

11. An apparatus, as set forth in claim 8, wherein said replicator is adapted to be coupled to a plurality of peripheral devices.

12. An apparatus, as set forth in claim 8, including a control circuit capable of preventing the digital network controller from being configured in response to detecting said replicator being disconnected from said portable computer.

13. An apparatus, as set forth in claim 12, wherein said control circuit masks the delivery of a control signal to said digital network controller in response to detecting said replicator being disconnected from said portable computer.

14. A method for interfacing a portable computer with a network, comprising:
coupling a replicator to a network;
delivering digital network signals to an external connector on said portable computer;
receiving said digital network signals at a digital network controller located within said portable computer;
converting said digital network signals to high-speed bus signals; and
delivering said high-speed bus signals onto an internal bus within said portable computer.

15. A method, as set forth in claim 14, wherein delivering said high-speed bus signals includes delivering said high-speed bus signals onto a peripheral component interface bus within said portable computer.

16. A method, as set forth in claim 14, wherein coupling a replicator includes coupling said replicator through an Ethernet connection, a token ring connection, and a modem connection.

17. An apparatus, comprising:
a portable computer having an external connector;
means for receiving digital network signals over said external connector, converting said digital network signals to high-speed bus signals, and delivering said high-speed bus signals onto an internal bus within said computer; and
a replicator located external said computer and being capable of being coupled to said portable computer, said replicator having an analog network circuit adapted to receive analog signals from a network and deliver corresponding digital network signals to the external connector on said portable computer.

18. An apparatus, as set forth in claim 17, wherein said internal bus is a peripheral component interface bus within said computer.

19. An apparatus, as set forth in claim 17, wherein said network includes an Ethernet connection, a token ring connection, and a modem connection.

20. An apparatus, as set forth in claim 17, wherein said replicator is adapted to be coupled to a plurality of peripheral devices.
